(19) United States
(12) Patent Application Publication
(10) Pub. No.: US 2017/0298171 A1
(43) Pub. Date: Oct. 19, 2017

(54) FLEXIBLE POLYUREA SEALANT COMPOSITIONS

(71) Applicant: Covestro LLC, Pittsburgh, PA (US)

(72) Inventors: Jay Johnston, Clinton, PA (US); Chelsey Seevers, Moon Township, PA (US); Ayla Pasquini, Pittsburgh, PA (US)

(21) Appl. No.: 15/512,597

(22) PCT Filed: Sep. 23, 2015
(86) PCT No.: PCT/US2015/051581

§ 371 Date: Mar. 20, 2017

Related U.S. Application Data
(60) Provisional application No. 62/054,563, filed on Sep. 24, 2014.

(51) Int. Cl. C08G 18/34; C08G 18/73; C08G 18/10; C08G 18/76; C09K 3/10

(52) U.S. Cl. CPC C08G 18/346; C08G 18/7671; C09K 3/10; C08G 18/10; C08G 18/73; C09K 2200/0665

(57) ABSTRACT

Disclosed are polyurea compositions and methods for using such composition as sealants, such as construction sealants.

### CROSS REFERENCE TO RELATED APPLICATION

This application is a national stage application under 35 U.S.C. §371 of PCT/US2015/051581, filed Sep. 23, 2015, which claims the benefit of U.S. Provisional Application No. 62/054,563, filed Sep. 24, 2014, both of which are incorporated by reference herein.

### FIELD OF INVENTION

The present invention relates to compositions and methods for using such compositions as sealants, such as construction sealants and structural sealants.

### BACKGROUND OF THE INVENTION

Sealants are widely used in building materials as waterproofing agents, environmental barriers, and to accommodate changes in the size of materials due to thermal, moisture and structural movements, including vibration and creep. As such, sealant compositions are often applied at, for example, expansion joints, control joints, and perimeter joints, of substrates, such as concrete substrates.

Polyurea sealants made from aspartic esters and isocyanates can be desirable in many applications, because, among other things, they can have fast reactivity, which means a fast return to service, they cure at low temperatures, they are insensitive to atmospheric and substrate moisture (meaning that they can cure while in contact with water without foaming) and they can have tunable physical properties, including good adhesion to most substrates. Certain sealants, however, should often exhibit a combination of several properties, such as a gel time of 5 to 20 minutes, high (>300%) elongation, moderate (50 to 250 psi) tensile strength, and high (at least 30 pli) tear resistance. Historically, polyurea sealants made from aspartic esters and isocyanates either have had insufficient flexibility and/or react too quickly to be useful in some applications unless significant amounts of plasticizers or other flexibilizers are used in the formulation.

As a result, it would be desirable to provide a polyurea sealant composition that can provide a flexible cured sealant suitable for use in sealant applications, such as application to expansion joints, control joints, and perimeter joints, of substrates, and which has the right level of reactivity.

### SUMMARY OF THE INVENTION

In some respects, the invention is directed to a sealant composition comprising: (A) a component comprising a polyisocyanate; and (B) a component comprising (B1) a polyaspartic ester and/or polyether diol, and (B2) a blend of different polyetheraspartic esters each having the formula:

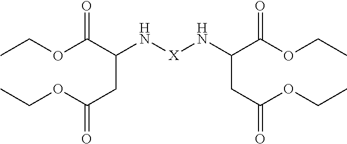

wherein X is the residue of a polyether polyamine, such as those having a repeat unit of the structure:

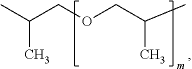

wherein m=2 to 35, such as m=2 to 6, or m=2 to 4.

In other respects, the present invention is directed to a sealant composition comprising: (A) a component comprising a polyisocyanate; and (B) a component comprising (B1) a polyaspartic ester having the formula (III):

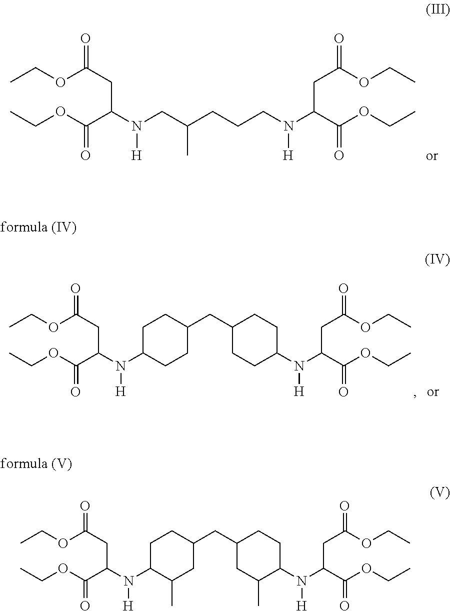

and (B2) a blend of different polyetheraspartic esters each having the formula:

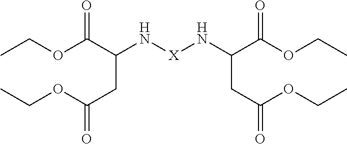

wherein X is the residue of a polyether polyamine, such as those having a repeat unit of the structure:

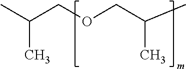

wherein m=2 to 35, such as m=2 to 6, or m=2 to 4.

### DETAILED DESCRIPTION

Various embodiments are described and illustrated in this specification to provide an overall understanding of the structure, function, operation, manufacture, and use of the disclosed products and processes. It is understood that the various embodiments described and illustrated in this specification are non-limiting and non-exhaustive. Thus, the invention is not limited by the description of the various non-limiting and non-exhaustive embodiments disclosed in this specification. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. Therefore, any such amendments comply with the requirements of 35 U.S.C. §112 and 35 U.S.C. §132(a). The various embodiments disclosed and described in this specification can comprise, consist of, or consist essentially of the features and characteristics as variously described herein.

Any patent, publication, or other disclosure material identified herein is incorporated herein by reference in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “certain embodiments”, “some embodiments”, “various non-limiting embodiments,” or the like, means that a particular feature or characteristic may be included in an embodiment. Thus, use of such phrases, and similar phrases, in this specification does not necessarily refer to a common embodiment, and may refer to different embodiments. Further, the particular features or characteristics may be combined in any suitable manner in one or more embodiments. Thus, the particular features or characteristics illustrated or described in connection with various embodiments may be combined, in whole or in part, with the features or characteristics of one or more other embodiments without limitation. Such modifications and variations are intended to be included within the scope of the present specification. In this manner, the various embodiments described in this specification are non-limiting and non-exhaustive.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges subsumed within the recited range. For example, a range of “ ”1 to 10” is intended to include all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. §112 and 35 U.S.C. §132(a).

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, the term “polymer” encompasses prepolymers, oligomers and both homopolymers and copolymers; the prefix “poly” in this context referring to two or more. As used herein, the term “molecular weight”, when used with reference to a hydroxyl-functional polymer, refers to a calculated molecular weight, which is determined by measuring the hydroxyl number of the polymer by ASTM D2849-69 Part 26 (1975) and then calculating the molecular weight by the formula: Molecular weight=(56100×functionality)/hydroxyl number.

In certain embodiments, the compositions described herein may be embodied as a two-component composition. As used herein, the term “two-component” refers to a composition comprising at least two components that are stored in separate containers because of their mutual reactivity. For instance, two-component polyurea compositions may comprise a hardener/crosslinker component comprising a polyisocyanate, and a separate binder component comprising an amino-functional compound. The two separate components are generally not mixed until shortly before application. When the two separate components are mixed and applied, the mutually reactive compounds in the two components react to crosslink and form a cured sealant.

As used herein, the term “sealant composition” refers to a mixture of chemical components that upon cure can join and/or seal an aperture (i.e., a gap) formed within a single substrate or between two or more different substrates when applied thereto. Such apertures may be found, for example, at a joint in a structure, such as an expansion joint, a control joint, or a perimeter joint.

As indicated, the compositions, such as sealant compositions, of the present invention, comprise a component comprising a polyisocyanate. As used herein, the term “polyisocyanate” refers to compounds comprising at least two un-reacted isocyanate groups. Polyisocyanates include diisocyanates and diisocyanate reaction products comprising, for example, biuret, isocyanurate, uretdione, urethane, urea, iminooxadiazine dione, oxadiazine trione, carbodiimide, acyl urea, allophanate groups, and combinations of any thereof.

The polyisocyanate component (A) may include any of the known polyisocyanates of polyurethane chemistry, including aromatic and aliphatic polyisocyanates. Examples of suitable lower molecular weight polyisocyanates (e.g., having a molecular weight of 168 to 300 g/mol) include, but are not limited to, 1,4-tetra-methylene diisocyanate; methylpentamethylene diisocyanate; 1,6-hexamethylene diisocyanate (HDI); pentamethylene diisocyanate (PDI), 2,2,4-trimethyl-1,6-hexamethylene diisocyanate; 1,12-dodecamethylene diisocyanate; cyclohexane-1,3- and -1,4-diisocyanate; 1-isocyanato-2-isocyanatomethyl cyclopentane; 1-isocyanato-3-isocyanatomethyl-3,5,5-trimethyl-cyclohexane (isophorone diisocyanate or IPDI); bis-(4-isocyanato-cyclohexyl)-methane; 1,3- and 1,4-bis-(isocyanatomethyl)-cyclohexane; bis-(4-isocyanatocyclo-hexyl)-methane; 2,4′-diisocyanato-dicyclohexyl methane; bis-(4-isocyanato-3-methyl-cyclohexyl)-methane; a,a,a′,a′-tetramethyl-1,3- and/or -1,4-xylylene diisocyanate; 1-isocyanato-1-methyl-4(3)-isocyanatomethyl cyclohexane; 2,4- and/or 2,6-hexahydro-toluylene diisocyanate; 1,3- and/or 1,4-phenylene diisocyanate; 2,4- and/or 2,6-tolune diisocyanate; 2,4- and/or 4,4′-diphenylmethane diisocyanate (MDI); 1,5-diisocyanato naphthalene; and combinations of any thereof.

In certain embodiments, polyisocyanate component (A) comprises an aliphatic diisocyanate, an aliphatic diisocyanate adduct, or an aliphatic diisocyanate prepolymer. Suitable aliphatic diisocyanates include, for example, hexamethylene diisocyanate (HDI); isophorone diisocyanate (IPDI); 2,4′- and/or 4,4′-diisocyanato-dicyclohexyl methane; adducts thereof; and prepolymers comprising residues thereof.

Additional suitable polyisocyanate components include derivatives of the above-mentioned monomeric diisocyanates. Suitable diisocyanate derivatives include, but are not limited to, polyisocyanates containing biuret groups as described, for example, in U.S. Pat. Nos. 3,124,605 and 3,201,372, which are incorporated herein by reference. Suitable diisocyanate derivatives also include, but are not limited to, polyisocyanates containing isocyanurate groups (symmetric trimers) as described, for example, in U.S. Pat. No. 3,001,973, which is incorporated herein by reference. Suitable diisocyanate derivatives also include, but are not limited to, polyisocyanates containing urethane groups as described, for example, in U.S. Pat. Nos. 3,394,164 and 3,644,457, which are incorporated herein by reference. Suitable diisocyanate derivatives also include, but are not limited to, polyisocyanates containing carbodiimide groups as described, for example, in U.S. Pat. No. 3,152,162, which is incorporated herein by reference. Suitable diisocyanate derivatives also include, but are not limited to, polyisocyanates containing allophanate groups. Suitable polyisocyanates also include, but are not limited to, polyisocyanates containing uretdione groups.

In certain embodiments, component (A) comprises an asymmetric diisocyanate trimer (iminooxadiazine dione ring structure) such as, for example, the asymmetric diisocyanate trimers described in U.S. Pat. No. 5,717,091, which is incorporated herein by reference. In various embodiments, component (A) may comprise an asymmetric diisocyanate trimer based on hexamethylene diisocyanate (HDI); isophorone diisocyanate (IPDI); or a combination thereof.

Isocyanate group-containing prepolymers and oligomers based on polyisocyanates may also be used in the polyisocyanate component (A). Polyisocyanate-functional prepolymers and oligomers may have an isocyanate content ranging from 0.5% to 30% by weight, and in some embodiments, 1% to 20% by weight, and may be prepared by the reaction of starting materials, such as, for example, isocyanate-reactive compounds such as polyols, at an NCO/OH equivalent number ratio of 1.05:1 to 10:1, and in some embodiments, 1.1:1 to 3:1.

Examples of other suitable polyisocyanates that may be used as component (A) alone or in combination with each other, and/or in combination with any of the polyisocyanates described above, include the polyisocyanates described in U.S. Pat. Nos. 5,126,170; 5,236,741; 5,489,704; 5,243,012; 5,736,604; 6,458,293; 6,833,424; 7,169,876; and in U.S. Patent Publication No. 2006/0247371, which are incorporated by reference herein.

A specific example of a polyisocyanate prepolymer that is suitable for use in the present invention is DESMODUR XP 2617 (an isocyanate prepolymer based on HDI; NCO content 12.0-13.0%, viscosity at 23° C. of 3,000-5,000 mPa·s). Other suitable exam pies include aromatic polyisocyanate prepolymers, including those having an isocyanate content of greater than 12.5%, including MDI-terminated polyether polyurethane prepolymers having an isocyanate content of greater than 12.5%, such as 16.0% or higher. Specific examples of suitable aromatic polyisocyanate prepolymers include, but are not limited to, BAYTEC MP-101 (a MDI-terminated polyether prepolymer based on polypropylene ether glycol; NCO content of 9.7-10.2%), and BAYTEC MP-160 (a MDI-terminated polyether polyurethane prepolymer based on polypropylene ether glycol; NCO content of 16.2-16.7%), all from Covestro LLC, Pittsburgh, Pa.

In certain embodiments of the present invention, the composition comprises: (B) a component comprising (B1) a polyaspartic ester and/or polyether diol.

Suitable polyether diols include, for example, polyaddition products of ethylene oxide, propylene oxide, tetrahydrofuran, butylene oxide and epichlorohydrin, co-addition and graft products thereof, as well as polyether diols obtained by condensation of dihydric alcohols or mixtures thereof and polyether diols obtained by alkoxylation of dihydric alcohols, amines and aminoalcohols.

Examples of suitable dihydric alcohols include diols having a molecular weight of 62 to 2000 which optionally contain ether groups, ester groups and/or carbonate groups. Specific examples of suitable dihydric alcohols include ethylene glycol, 1,2- and 1,3-propanediol, 1,3-, 2,3- and 1,4-butanediol, 1,6-hexanediol, diethylene glycol, dipropylene glycol, neopentyl glycol and mixtures of these diols. Other suitable diols include ethanediol, 1,5-pentanediol, 2,2-dimethyl-1,3-propanediol, 1,4-dihydroxycyclohexane, 1,4-dimethylolcyclohexane, 1,8-octanediol, 1,10-decanediol, 1,12-dodecanediol, triethylene glycol, tetraethylene glycol, tripropylene glycol, tetrapropylene glycol, polycarbonate diols having hydroxyl numbers of 56 to 168 (which may be obtained by reacting any of the preceding diols with diphenyl carbonate, dimethyl carbonate, diethylene glycol carbonate or phosgene), and dimeric fatty alcohols. Cycloaliphatic dihydroxyl compounds are also suitable as the dihydric alcohol(s). Mixtures of any of the preceding diols can also be used.

As used herein, the term “dimeric fatty alcohol” means diols which can be obtained from technical dimerized fatty acids. Dimerized fatty acids are those containing at least 75% by weight of dimeric acids, i.e., dicarboxylic acids having an average of 30 to 45 carbon atoms per molecule. The conversion of the dimeric fatty acids into dimeric fatty alcohols can be carried out, for example, by reduction of the carboxyl groups to hydroxyl groups, esterification of the carboxyl groups with the previously described low molecular weight diols or by alkoxylation of the carboxyl groups, for example, by means of ethylene oxide and/or propylene oxide. An example of a dimeric fatty alcohol suitable for use in preparing the polyether diol is PRIPOL 2033 from Unichema.

In some embodiments of the present invention, the polyether diol used to prepare the isocyanate-terminated prepolymer comprises a polyoxypropylene diol having a molecular weight of 2000 to 6000, such as 2500 to 5000. Such polyether diols may have an unsaturated terminal group content of less than or equal to 0.02 milliequivalents, such as from 0.005 to 0.015 milliequivalents (method used for determination ASTM D2849-69) per gram polyol, which are obtained by known methods by double metal cyanide complex-catalyzed (DMC-catalyzed) polymerization of alkylene oxides, such as propylene oxides, such as is described, for example, in U.S. Pat. No. 5,158,922 (e.g., Example 30) or European Patent 654,302 (p. 5, line 26 to p. 6, line 32). A specific example of a polyether diol suitable for use in preparing the isocyanate-terminated prepolymer is ARCOL E-351 (a 2800 molecular weight polyoxypropylene diol, available from Covestro LLC, Pittsburgh, Pa.).

As indicated, in addition to or in lieu of the polyether diol, component (B) may comprise a polyaspartic ester.

The polyaspartic ester may include one or more polyaspartic esters corresponding to formula (I):

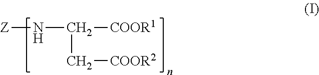

wherein: n is an integer of 2 to 6; Z represents an aliphatic residue; and R¹ and R² represent organic groups that are inert to isocyanate groups under reaction conditions and that may be the same or different organic groups.

In formula (I), the aliphatic residue Z may correspond to a straight or branched alkyl and/or cycloalkyl residue of an n-valent polyamine that is reacted with a dialkylmaleate in a Michael addition reaction to produce a polyaspartic ester. For example, the residue Z may correspond to an aliphatic residue from an n-valent polyamine including, but not limited to, ethylene diamine; 1,2-diaminopropane; 1,4-diaminobutane; 1,6-diaminohexane; 2,5-diamino-2,5-dimethylhexane; 2,2,4- and/or 2,4,4-trimethyl-1,6-diaminohexane; 1,11-diaminoundecane; 1,12-diaminododecane; 1-amino-3,3,5-trimethyl-5-amino-methylcyclohexane; 2,4′- and/or 4,4′-diaminodicyclohexylmethane; 3,3′-dimethyl-4,4′-diaminodicyclohexylmethane; 2,4,4′-triamino-5-methyldicyclohexylmethane; polyether polyamines with aliphatically bound primary amino groups and having a number average molecular weight (Mₙ) of 148 to 6000 g/mol; isomers of any thereof, and combinations of any thereof.

In certain embodiments, the residue Z may be obtained from 1,4-diaminobutane; 1,6-diaminohexane; 2,2,4- and/or 2,4,4-trimethyl-1,6-diaminohexane; 1-amino-3,3,5-trimethyl-5-aminomethylcyclohexane; 4,4′-diaminodicyclohexylmethane; 3,3′-dimethyl-4,4′-diaminodicyclohexylmethane; or 1,5-diamine-2-methyl-pentane.

The phrase “inert to isocyanate groups under reaction conditions,” which is used to define groups R¹ and R² in formula (I), means that these groups do not have Zerevitinov-active hydrogens. Zerevitinov-active hydrogen is defined in Rompp's Chemical Dictionary (Rommp Chemie Lexikon), 10th ed., Georg Thieme Verlag Stuttgart, 1996, which is incorporated herein by reference. Generally, groups with Zerevitinov-active hydrogen are understood in the art to mean hydroxyl (OH), amino (NHₓ), and thiol (SH) groups. In various embodiments, R¹ and R², independently of one another, are C₁ to C₁₀ alkyl residues, such as, for example, methyl, ethyl, or butyl residues.

In certain embodiments, the polyaspartic ester comprises one or more compounds corresponding to formula (I) in which n is an integer from 2 to 6, in some embodiments n is an integer from 2 to 4, and in some embodiments n is 2. In embodiments, where n=2, the polyaspartic ester may comprise one or more compounds corresponding to formula (II):

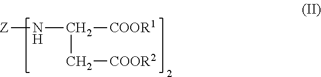

The polyaspartic ester may be produced by reacting the corresponding primary polyamines of the formula:

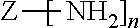

with maleic or fumaric acid esters of the formula:

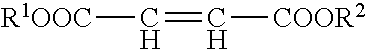

Examples of suitable polyamines include the above-mentioned diamines. Examples of suitable maleic or fumaric acid esters include dimethyl maleate, diethyl maleate, dibutyl maleate, and the corresponding fumarates.

The production of the polyaspartic ester from the above-mentioned polyamine and maleic/fumaric acid ester starting materials may take place within a temperature range of 0° C. to 100° C. The starting materials may be used in amounts such that there is at least one equivalent, and in some embodiments approximately one equivalent, of olefinic double bonds in the maleic/fumaric acid esters for each equivalent of primary amino groups in the polyamine. Any starting materials used in excess may, if desired, be separated off by distillation following the reaction. The reaction may take place in the presence or absence of suitable solvents, such as methanol, ethanol, propanol, and/or dioxane.

In certain embodiments, the polyaspartic ester comprises a reaction product of two equivalents of diethyl maleate with one equivalent of 1,5-diamine-2-methyl-pentane; 4,4′-diaminodicyclohexylmethane; or 3,3′-dimethyl-4,4′-diaminodicyclohexylmethane. These reaction products may have the molecular structures shown in formulas (III)-(V), respectively:

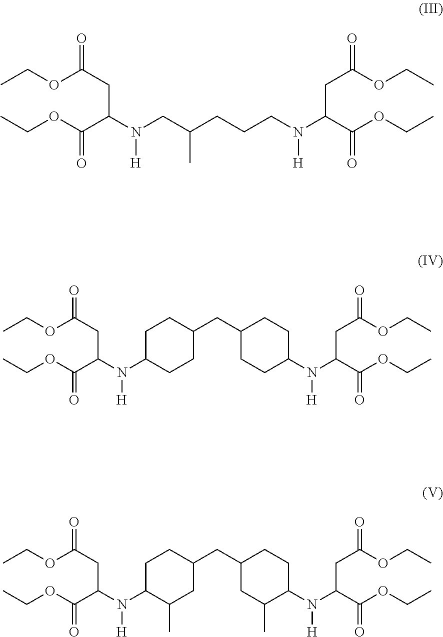

In some embodiments, the polyaspartic ester comprises a polyaspartic ester as shown in Formula (III).

In certain embodiments, component (B) comprises a mixture of a polyether diol and a polyaspartic ester, such as the polyaspartic ester shown in Formula (III). In some embodiments, the relative weight ratio of the polyether diol to the polyaspartic ester shown in Formula (III) in the mixture is 1:90 to 90:1, such as 1:10 to 10:1, 1:5 to 5:1, 1:1: to 1:2.

In some embodiments of the present invention, the polyaspartic ester, such as the polyaspartic ester shown in Formula (III), is present in component (B) in an amount of 0.1 to 80 percent by weight, such as 10 to 60 percent by weight, based on the total weight of reactants in component (B). In some embodiments, the polyaspartic ester, such as the polyaspartic ester shown in Formula (III), is present in component (B) in an amount of 30 to 50 percent by weight, such as 35 to 45 percent by weight, based on the total weight of reactants in component (B).

Suitable polyaspartic esters are commercially available from Covestro LLC, Pittsburgh, Pa., USA, under the tradenames DESMOPHEN NH 1220, DESMOPHEN NH 1420, DESMOPHEN NH 1520, and DESMOPHEN NH 1521.

As indicated, component (B) of the compositions of the present invention comprises (B2) a blend of different polyetheraspartic esters each having the formula (VI):

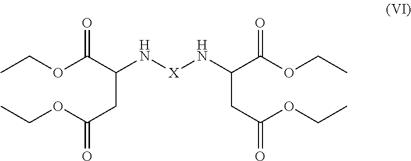

wherein X is the residue of a polyether polyamine, such as those having a repeat unit of the structure:

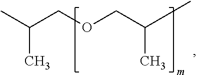

wherein m=2 to 35.

The blend of polyetheraspartic esters comprises at least two different polyetheraspartic esters which have a different number of repeating units in X. In certain embodiments, the blend is such that the average value of m is in the range of 2 to 4, such as 2.5 to 3.

Such polyetheraspartic esters may be prepared by reacting a blend of polyether polyamines with a dialkylmaleate. Such polyetheraspartic esters may be prepared, for example, by employing the reactants in amounts such that there is at least one equivalent, and in some embodiments approximately one equivalent, of olefinic double bonds for each equivalent of primary amino groups.

Suitable polyether polyamines that may be reacted with dialkylmaleates in Michael addition reactions produce polyetheraspartic esters for component (B2) include the JEFFAMINE polyetheramines commercially available from Huntsman Corporation, The Woodlands, Tex. In certain embodiments, the blend of polyether polyamines comprises a blend of polyether polyamines according to the formula (VII), wherein p is a number having an average value of at least 2, such as 2 to 35, or 2 to 8, or 2.5 to 6.1:

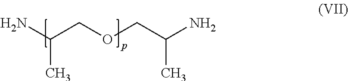

wherein the blend comprises: (1) at least 50 to 99% by weight, such as 50 to 90% by weight, or, in some cases, 80 to 90 percent by weight, of a polyether polyamine according to the formula (VII) wherein p has an average value of 2.5; and (2) 1 to 50% by weight, such as 10 to 50% by weight, or, in some cases, 10 to 20 percent by weight, of a polyether polyamine according to the formula (VII) wherein p has an average value of 6.1

An example of a blend of polyetheraspartic esters that is suitable for use in the present invention is DESMOPHEN NH 2850 XP, from Covestro Deutschland AG, Leverkusen, Germany, which has an equivalent weight of 290, a viscosity at 25° C. of about 120 mPa·s, and an amine value of about 195 mg KOH/g.

In some embodiments of the present invention, the blend of polyetheraspartic esters is present in component (B) in an amount of 10 to 80 percent by weight, such as 20 to 60, or 30 to 50 percent by weight, based on the total weight of reactants in component (B).

The compositions of the present invention may be formulated so that the ratio of isocyanate groups of component (A) to isocyanate-reactive groups of component (B) (NCO:(NHₓ+OH)) is 1:5 to 5:1, and in some embodiments, 1:3 to 3:1, 1:2 to 2:1, 1:1.5 to 1.5:1, 0.5:1 to 5:1, 1.5:1 to 3:1, or 1:1 to 1.5:1. The compositions of the present invention may be formulated so that an approximately 1:1 mixture by volume of component (A) and component (B) are mixed to form the sealant composition having an (NCO:(NHₓ+OH)) ratio as described above, for example, in some embodiments 1:1, and in other embodiments, ranging from 1:1 to 1.5:1 or 1:1 to 1.3:1.

The compositions of the present invention may be used, for example, as sealants. As a result, in certain embodiments, the compositions of the present invention may further include non-functional plasticizers, fillers, pigments, driers, additives, light stabilizers, antioxidants, thixotropic agents, catalysts, silane adhesion promoters and, where appropriate, further auxiliaries and additives in accordance with known methods of producing sealants.

Sealant compositions of the present invention may, if desired, contain a filler. For example, in some cases, a filler, such as calcium carbonate and/or titanium dioxide, is present in the composition of the present invention in an amount of up to 10 percent by weight. In other embodiments, a filler may be present in an amount of at least 10 percent by weight, such as at least 20 percent by weight, at least 25 percent by weight, or in some cases, at least 30 percent by weight and/or up to 70 percent by weight, such as up to 60 percent by weight, or, in some cases, up to 50 percent by weight, the weight percents being based on the total weight of the composition.

Examples of other suitable fillers for use in the inventive sealant compositions include carbon black, precipitated hydrated silicas, mineral chalk materials and precipitated chalk materials. Examples of suitable non-functional plasticizers include phthalic acid esters, adipic acid esters, alkylsulphonic acid esters of phenol, or phosphoric acid esters. Examples of thixotropic agents include pyrogenic hydrated silicas, polyamides, products derived from hydrogenated castor oil, and also polyvinyl chloride. Reactive primary amine thixotropes such as, diethylene toluene diamine, can be used if desired.

The sealant compositions of the present invention can be used for the joining and sealing of materials made, for example, from metal, ceramic, glass, plastic, wood, concrete and other construction materials. In some embodiments, the compositions of the present invention may be used to seal an aperture (i.e., a gap) by depositing the composition over at least a portion of the aperture and allowing the composition to cure to seal the aperture. Such apertures may be present within a single substrate or between two or more different substrates. The compositions may be applied over an aperture or onto surfaces using various techniques, however, in certain embodiments, the composition is applied by use of a two-component caulking gun of the type familiar to those skilled in the art. Such apertures may be found, for example, at a joint in a structure, such as an expansion joint, a control joint, or a perimeter joint.

It has been discovered, surprisingly, that sealant compositions of the invention can produce a sufficiently flexible cured sealant using aromatic polyisocyanate prepolymers in which the isocyanate content is well above 12.5%, such as 16% or higher. Historically, polyurea sealants using an aromatic polyisocyanate prepolymer and a polyaspartic ester become too brittle to be useful when the isocyanate content of the polyisocyanate prepolymer is above 12.5%. It has also been discovered that sealant compositions of the present invention in which an aliphatic polyisocyanate prepolymer is used can produce sealants having properties similar to flexible construction sealants.

Sealants formed from the compositions of the present invention can, in at least some cases, exhibit a desirable combination of properties. For example, in some embodiments, sealants formed from the compositions of the present invention have (i) an ultimate tensile strength of 50 to 2000 psi, such as 50 to 250 psi, such as 100 to 200 psi or 150 to 200 psi; (ii) a breaking elongation of >50%, such as >300%, such as greater than 400% or greater than 500%; (iii) a tear resistance of at least 30 pli, such as 30 to 60 pli or 115 to 350 pli; and/or (iv) a Shore A hardness (at 1 second and 5 seconds) of 20 to 100, such as 25 to 45. In the present invention, the tensile strength and breaking elongation can be determined according to ASTM D412, Method A, the tear resistance can be determined by ASTM D624, Die “C”, and the Shore A hardness according to ASTM D-2240.

The non-limiting and non-exhaustive examples that follow are intended to further describe various non-limiting and non-exhaustive embodiments without restricting the scope of the embodiments described in this specification.

### EXAMPLES

Unless otherwise specified, all percentages are to be understood as being percentages by weight.

The following ingredients were used in preparing the compositions in the Examples:

Antioxidant—a hindered phenol antioxidant (3,5-di-t-4-hydroxy-hydrocinnamic acid and C₇₋₉-branched alkyl esters), commercially available as IRGANOX 1135from Ciba Specialty Chemicals;

Isocyanate A—a largely linear NCO prepolymer based on hexamethylene diisocyanate, having an NCO content 12.5±1.0 wt %, commercially available as DESMODUR XP 2617 from Covestro LLC;

Isocyanate B—a diphenylmethane diisocyanate (MDI)-terminated prepolymer, having an NCO group content of 10%, viscosity at 25° C. of 2500 mPa·s, commercially available as BAYTEC MP-101 from Covestro LLC;

Isocyanate C—a diphenylmethane diisocyanate (MDI)-terminated prepolymer, having an NCO group content of 16.5%, viscosity at 25° C. of 600 mPa·s, commercially available as BAYTEC MP-160 from Covestro LLC;

Light stabilizer A—a hindered amine UV stabilizer, commercially available as TINUVIN 1130 from Ciba Specialty Chemicals;

Light stabilizer B—a hindered amine light stabilizer (“HALS”), commercially available as TINUVIN 292 from Ciba Specialty Chemicals;

Plasticizer—a phthalate-free general purpose plasticizer (alkylsulfonic acid ester of phenol) commercially available as MESAMOLL from Lanxess Deutschland GmbH;

Polyaspartic ester A—commercially available as DESMOPHEN NH 1220 from Covestro LLC;

Polyaspartic ester B—commercially available as DESMOPHEN NH 1420 from Covestro LLC;

Polyaspartic ester C—commercially available as DESMOPHEN NH 1520 from Covestro LLC;

Polyaspartic ester blend—a blend of polyetheraspartic esters having an amine value of 195 mg KOH/g, viscosity @25n ° C. of 120 mPa·s, commercially available as DESMOPHEN NH 2850 XP, from Covestro Deutschland AG, Leverkusen, Germany;

Polyol—a 2,800 molecular weight polyoxypropylene diol modified with ethylene oxide PO (84.3%)/EO (15.7%) having a functionality of about 2, and having a hydroxyl number of about 40 meq/g KOH commercially available as ARCOL E-351 from Covestro LLC; and

Silane— [symbol] -glycidoxypropyltrimethoxysilane commercially available as SILQUEST A-187 from Momentive Performance Materials Inc.;

In the tables below, physical property measurements were made as follows: ultimate tensile strength was measured by ASTM D 412 Tensile Test for Rubber Die C; ultimate elongation was measured by ASTM 412 Tensile Test for Rubber Die C; tear resistance was measured by TER624 -Die “C” Tear ASTM D 624 - D 3489; hardness at 1 sec (Shore A) was measured by ASTM D 2240 Durometer Hardness, Shore A @1 and 5 Sec; and tensile strength at 100%, 200% and 300% elongation was measured by ASTM D 412 Tensile test for Rubber-Die C.

### Example 1

Sealant compositions were prepared using the ingredients and amounts listed in Table 1 (amounts normalized to 100 parts by weight). The gel time of the sealant compositions was evaluated and the results are also set forth in Table 1.

TABLE 1

| | Example | | | | | |
|---|---|---|---|---|---|---|
| | 1A | 1B | 1C | 1D | 1E | 1F |
| lsocyanate A | 49.60 | 49.46 | 49.51 | 49.55 | 49.59 | 49.65 |
| Polyaspartic ester | 42.41 | 41.19 | 31.05 | 24.22 | 17.52 | 7.30 |
| blend | | | | | | |
| Polyol | — | 4.80 | 7.32 | 9.08 | 10.71 | 13.34 |
| Polyaspartic ester A | — | — | 7.57 | 12.61 | 17.64 | 25.18 |
| Plasticizer | 3.43 | — | — | — | — | — |
| Light stabilizer A | 0.14 | 0.14 | 0.14 | 0.14 | 0.14 | 0.14 |
| Light stabilizer B | 0.14 | 0.14 | 0.14 | 0.14 | 0.14 | 0.14 |
| Antioxidant | 0.38 | 0.38 | 0.38 | 0.38 | 0.38 | 0.38 |
| Silane | 0.13 | 0.13 | 0.13 | 0.13 | 0.13 | 0.13 |
| Titanium Dioxide | 3.78 | 3.76 | 3.76 | 3.76 | 3.75 | 3.75 |
| Gel time (minutes) | 474 | 380 | 100.5 | 92.5 | 33.8 | 11.6 |

### Example 2

Sealant compositions were prepared using the ingredients and amounts listed in Table 2 (amounts normalized to 100 parts by weight). The gel time of the sealant compositions was evaluated and the results are also set forth in Table 2.

TABLE 2

| | 2A | 2B | 2C | 2D |
|---|---|---|---|---|
| Isocyanate A | 45.54 | 39.46 | 44.16 | 45.12 |
| Polyaspartic ester A | — | 60.54 | — | — |
| Polyaspartic ester B | — | — | 55.84 | — |
| Polyaspartic ester C | — | — | — | 54.88 |
| Polyaspartic ester blend | 54.46 | — | — | — |
| Gel time (minutes) | 237.8 | 3.1 | 83.2 | 262.9 |

### Example 3

Sealant compositions were prepared using the ingredients and amounts listed in Table 3 (amounts normalized to 100 parts by weight). The gel time of the sealant compositions was evaluated and the results are also set forth in Table 3.

TABLE 3

| | 3A | 3B | 3C | 3D |
|---|---|---|---|---|
| Isocyanate B | 40.08 | 34.28 | 38.75 | 39.67 |
| Polyaspartic ester A | — | 65.72 | — | — |
| Polyaspartic ester B | — | — | 61.25 | — |
| Polyaspartic ester C | — | — | — | 60.33 |
| Polyaspartic ester blend | 59.92 | — | — | — |
| Gel time (minutes) | 45.6 | 0.5 | 8.8 | 78.9 |

### Example 4

A sealant composition was prepared using the ingredients and amounts listed in Table 4 (amounts normalized to 100 parts by weight). The sealant composition was tested for various physical properties and the results are also set forth in Table 4.

TABLE 4

| Ingredient | Amount |
|---|---|
| Isocyanate C | 48.49 |
| Plasticizer | 5.00 |
| Polyaspartic ester blend | 26.69 |
| Polyaspartic ester A | 18.85 |
| Titanium dioxide | 0.49 |
| Light stabilizer A | 0.14 |
| Light stabilizer B | 0.14 |
| Antioxidant | 0.14 |
| Silane | 0.07 |
| Ultimate tensile strength (psi) | 653 |
| Ultimate elongation (%) | 325.8 |
| Tear resistance (pli) | 288.3 |
| Hardness at 1 sec (Shore A) | 96 |
| Hardness at 5 sec (Shore A) | 93 |
| Tensile strength at 100% elongation (psi) | 504.3 |
| Tensile strength at 200% elongation (psi) | 519.7 |
| Tensile strength at 300% elongation (psi) | 567 |

### Example 5

A sealant composition was prepared using the ingredients and amounts listed in Table 5 (amounts normalized to 100 parts by weight). The sealant composition was tested for various physical properties and the results are also set forth in Table 5.

TABLE 5

| Ingredient | Amount |
|---|---|
| Isocyanate A | 49.55 |
| Polyol | 9.08 |
| Polyaspartic ester blend | 24.22 |
| Titanium dioxide | 3.76 |
| Light stabilizer A | 0.14 |
| Light stabilizer B | 0.14 |
| Antioxidant | 0.38 |
| Silane | 0.13 |
| Polyaspartic ester A | 12.61 |
| Ultimate tensile strength (psi) | 91.1 |
| Ultimate elongation (%) | 495.3 |
| Tear resistance (pli) | 22.5 |
| Hardness at 1 sec (Shore A) | 30 |
| Hardness at 5 sec (Shore A) | 20 |
| Tensile strength at 100% elongation (psi) | 42.9 |
| Tensile strength at 200% elongation (psi) | 53.2 |
| Tensile strength at 300% elongation (psi) | 62.9 |

### Example 6

Sealant compositions were prepared using the ingredients and amounts listed in Table 6 (amounts normalized to 100 parts by weight). The sealant compositions were tested for various physical properties and the results are also set forth in Table 6.

TABLE 6

| Ingredient | 6A | 6B | 6C | 6D |
|---|---|---|---|---|
| Isocyanate C | 45.88 | 43.28 | 51.09 | 48.49 |
| Polyaspartic ester blend | 25.49 | 24.30 | 27.88 | 26.69 |
| Plasticizer | 10.00 | 15.00 | — | 5.00 |
| Polyaspartic ester A | 17.65 | 16.45 | 20.05 | 18.85 |
| Light stabilizer B | 0.14 | 0.14 | 0.14 | 0.14 |
| Light stabilizer A | 0.14 | 0.14 | 0.14 | 0.14 |
| Titanium dioxide | 0.49 | 0.49 | 0.49 | 0.49 |
| Antioxidant | 0.14 | 0.14 | 0.14 | 0.14 |
| Silane | 0.07 | 0.07 | 0.07 | 0.07 |
| Ultimate tensile strength (psi) | 408.3 | 257.7 | 1846.7 | 653 |
| Ultimate elongation (%) | 314.3 | 453.2 | 54.8 | 325.8 |
| Tear resistance (pli) | 250 | 115 | 342.3 | 288.3 |
| Hardness at 1 sec (Shore A) | 88 | 70 | 94 | 96 |
| Hardness at 5 sec (Shore A) | 82 | 60 | 94 | 93 |
| Tensile strength at 100% | 358.3 | 181.7 | — | 504.3 |
| elongation (psi) | | | | |
| Tensile strength at 200% | 365 | 192.7 | — | 519.7 |
| elongation (psi) | | | | |
| Tensile strength at 300% | 403 | 218.3 | — | 567 |
| elongation (psi) | | | | |

### Example 7

Sealant compositions were prepared using the ingredients and amounts listed in Table 7 (amounts normalized to 100 parts by weight). The sealant compositions were tested for various physical properties and the results are also set forth in Table 7.

TABLE 7

| Ingredient | 7A | 7B | 7C | 7D | 7E | 7F |
|---|---|---|---|---|---|---|
| Isocyanate A | 49.60 | 49.46 | 49.51 | 49.55 | 49.59 | 49.65 |
| Polyol | — | 4.80 | 7.32 | 9.08 | 10.71 | 13.34 |
| Plasticizer | 3.43 | — | — | — | — | — |
| Polyaspartic | 42.41 | 41.19 | 31.05 | 24.22 | 17.52 | 7.30 |
| ester blend | | | | | | |
| Titanium | 3.78 | 3.76 | 3.76 | 3.76 | 3.75 | 3.74 |
| dioxide | | | | | | |
| Light stabilizer | 0.14 | 0.14 | 0.14 | 0.14 | 0.14 | 0.14 |
| A | | | | | | |
| Light stabilizer | 0.14 | 0.14 | 0.14 | 0.14 | 0.14 | 0.14 |
| B | | | | | | |
| Antioxidant | 0.38 | 0.38 | 0.38 | 0.38 | 0.38 | 0.38 |
| Silane | 0.13 | 0.13 | 0.13 | 0.13 | 0.13 | 0.13 |
| Polyaspartic | — | — | 7.57 | 12.61 | 17.64 | 25.18 |
| ester A | | | | | | |
| Ultimate tensile | 52.6 | 179.3 | 175.3 | 96.5 | 192.7 | 193.3 |
| strength (psi) | | | | | | |
| Ultimate | 977.1 | 759 | 661.7 | 926.1 | 574.1 | 530.3 |
| elongation (%) | | | | | | |
| Tear resistance | 19.3 | 37.5 | 36.8 | 22.8 | 40.9 | 50 |
| (pli) | | | | | | |
| Hardness at | 20 | 28 | 36 | 27 | 32 | 40 |
| 1 sec | | | | | | |
| (Shore A) | | | | | | |
| Hardness at | 12 | 26 | 34 | 22 | 28 | 34 |
| 5 sec | | | | | | |
| (Shore A) | | | | | | |
| Tensile | 30.9 | 59.7 | 64.7 | 36.7 | 66.2 | 72.2 |
| strength | | | | | | |
| at 100% | | | | | | |
| elongation | | | | | | |
| (psi) | | | | | | |
| Tensile | 32.5 | 71.2 | 80.3 | 41.3 | 85.8 | 95.5 |
| strength | | | | | | |
| at 200% | | | | | | |
| elongation (psi) | | | | | | |
| Tensile | 33.3 | 80.4 | 93.6 | 44.6 | 103.6 | 118.3 |
| strength | | | | | | |
| at 300% | | | | | | |
| elongation (psi) | | | | | | |

Various aspects of the subject matter described herein are set out in the following numbered clauses:

1. A sealant composition comprising: (A) a component comprising a polyisocyanate; and (B) a component comprising: (B1) a polyaspartic ester and/or polyether diol, and (B2) a blend of different polyetheraspartic esters each having the formula:

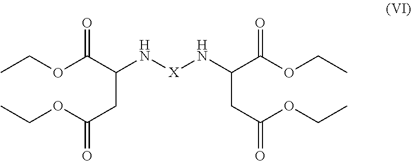

wherein X is the residue of a polyether polyamine.

2. The composition according to clause 1, wherein X has a repeat unit of the structure:

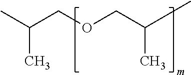

wherein m=2 to 35.

3. The composition according to clause 2, wherein the blend of polyetheraspartic esters comprises at least two different polyetheraspartic esters in which the number of repeating units in X is different and the blend is such that the average value of m is in the range of 2 to 4.

4. The sealant composition according to any one of clauses 1 to 3, wherein the polyisocyanate comprises a 2,4- and/or 4,4′-diphenylmethane diisocyanate terminated polyether prepolymer based on polypropylene ether glycol having an isocyanate content of greater than 12.5%.

5. The sealant composition of claim 4, wherein the isocyanate content is at least 16%.

6. The sealant composition according to any one of clauses 1 to 5, wherein (B) comprises a polyoxypropylene diol having a molecular weight of 2500 to 5000.

7. The sealant composition according to any one of clauses 1 to 6, wherein (B) comprises a polyaspartic ester of the formula:

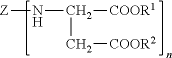

wherein: n is an integer of 2 to 6; Z represents an aliphatic residue; and R¹ and R² represent organic groups that are inert to isocyanate groups under reaction conditions and that may be the same or different organic groups.

8. The sealant composition according to clause 7, wherein (B) comprises a polyaspartic ester of the formula:

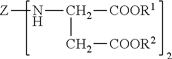

9. The sealant composition according to any one of clauses 1 to 8, wherein (B1) comprises a polyaspartic ester selected from the group consisting of formulae (III), (IV) and (V):

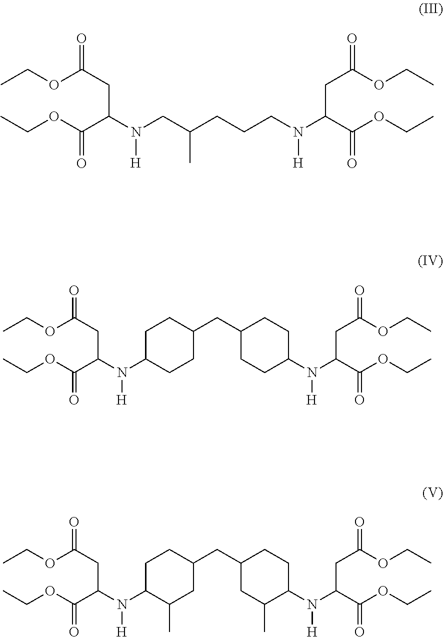

10.The sealant composition according to clause 9, wherein (B) further comprises a polyether diol.

11. The sealant composition according to clause 10, wherein a relative weight ratio of the polyether diol to the polyaspartic ester in the mixture is 1:1: to 1:2.

12. The sealant composition according to clause 10, wherein the polyaspartic ester is present in component (B) in an amount 30 to 50 percent by weight, based on the total weight of reactants in component (B).

13. The sealant composition according to any one of clauses 1 to 12, wherein the polyetheraspartic esters are the reaction product of a blend of polyether polyamines with a dialkylmaleate, wherein the blend of polyether polyamines comprises a blend of polyether polyamines according to the formula:

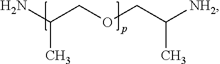

wherein p is a number having an average value of 2 to 35.

14.The sealant composition according to clause 13, wherein the blend of polyether polyamines comprises: (1) 50 to 99% by weight of polyether polyamines wherein x has an average value of 2.5; and (2) 1 to 50% by weight of polyether polyamines wherein p has an average value of 6.1

15. The sealant composition according to clause 14, wherein the blend of polyetheraspartic esters is present in component (B) in an amount of 20 to 60 percent by weight, based on the total weight of reactants in component (B).

16. The sealant composition according to any one of clauses 1 to 15, wherein a ratio of isocyanate groups of component (A) to isocyanate-reactive groups of component (B) is 1:1 to 1.5:1.

17.A method of using the sealant composition according to any one of clauses 1 to 16, comprising: (a) applying the composition over an aperture; and (b) allowing the composition to cure and seal the aperture.

18. The method according to clause 17, wherein the cured sealant has (i) an ultimate tensile strength of 50 to 2000 psi, (ii) a breaking elongation of >50%, and (iii) a tear resistance of at least 30 pli.

19.A sealant composition comprising: (A) a component comprising a polyisocyanate; and (B) a component comprising: (B1) a polyaspartic ester selected from the group consisting of formulae (Ill), (IV) and (V):

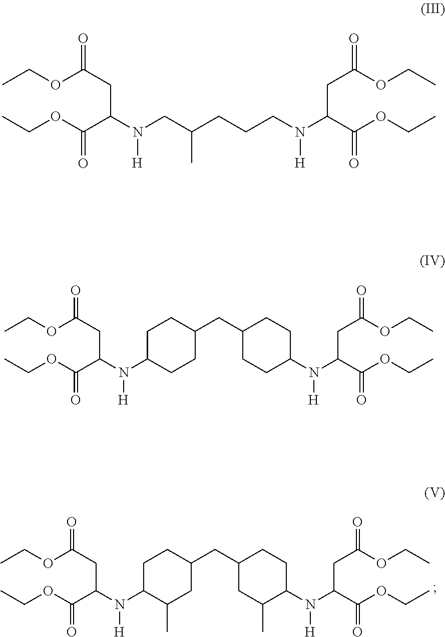

and (B2) a blend of different polyetheraspartic esters each having the formula (VI):

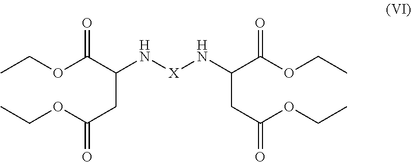

wherein X is the residue of a polyether polyamine.

20. The composition according to clause 19, wherein X has a repeat unit of the structure:

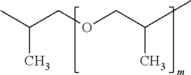

wherein m=2 to 35.

21.The composition according to clause 20, wherein the blend of polyetheraspartic esters comprises at least two different polyetheraspartic esters in which the number of repeating units in X is different and the blend is such that the average value of m is in the range of 2 to 4.

22. The sealant composition according to any one of clauses 19 to 21, wherein the polyisocyanate comprises a 2,4- and/or 4,4′-diphenylmethane diisocyanate terminated polyether prepolymer based on polypropylene ether glycol having an isocyanate content of greater than 12.5%.

23. The sealant composition according to clause 22, wherein the isocyanate content is at least 16%.

24. The sealant composition according to any one of clauses 19 to 23, wherein (B) further comprises a polyoxypropylene diol having a molecular weight of 2500 to 5000.

25. The sealant composition according to clause 24, wherein a relative weight ratio of the polyether diol to the polyaspartic ester in the mixture is 1:1: to 1:2.

26. The sealant composition according to any one of clauses 19 to 25, wherein the polyaspartic ester is present in component (B) in an amount 30 to 50 percent by weight, based on the total weight of reactants in component (B).

27. The sealant composition according to any one of clauses 19 to 26, wherein the polyetheraspartic esters are the reaction product of a blend of polyether polyamines with a dialkylmaleate, wherein the blend of polyether polyamines comprises a blend of polyether polyamines according to the formula:

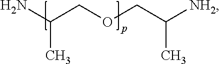

wherein p is a number having an average value of 2 to 35.

28. The sealant composition according to clause 27, wherein the blend of polyether polyamines comprises: (1) 50 to 99% by weight of polyether polyamines wherein p has an average value of 2.5; and (2) 1 to 50% by weight of a polyether polyamines wherein p has an average value of 6.1.

29. The sealant composition according to clause 28, wherein the blend of polyetheraspartic esters is present in component (B) in an amount of 20 to 60 percent by weight, based on the total weight of reactants in component (B).

30.The sealant composition according to any one of clauses 19 to 29, wherein a ratio of isocyanate groups of component (A) to isocyanate-reactive groups of component (B) is 1:1 to 1.5:1.

31.A method of using the sealant composition according to any one of clauses 19 to 32, comprising: (a) applying the composition over an aperture; and (b) allowing the composition to cure and seal the aperture.

32.The method according to clause 31, wherein the cured sealant has (i) an ultimate tensile strength of 50 to 2000 psi, (ii) a breaking elongation of >50%, and (iii) a tear resistance of at least 30 pli.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant(s) reserve the right to amend the claims during prosecution to add features as variously described in this specification, and such amendments comply with the requirements of 35 U.S.C. §112, first paragraph, and 35 U.S.C. §132(a).

What is claimed is:

1. A sealant composition comprising:
(A) a component comprising a polyisocyanate; and
(B) a component comprising:
(B1) a polyaspartic ester and/or polyether diol, and
(B2) a blend of at least two different polyetheraspartic esters each having the formula (VI): 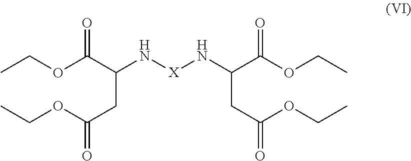
wherein X is the residue of a polyether polyamine and has a repeat unit of the structure: 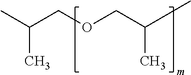
wherein m is different in each polyetheraspartic ester and wherein m is in the range of 2 to 35.

2. The sealant composition according to claim 1, wherein the polyisocyanate comprises a 2,4- and/or 4,4′-diphenylmethane diisocyanate terminated polyether prepolymer based on polypropylene ether glycol having an isocyanate content of greater than 12.5%.

3. The sealant composition according to claim 2, wherein the isocyanate content is greater than 16%.

4. The sealant composition according to claim 1, wherein (B) comprises a polyoxypropylene diol having a molecular weight of 2500 to 5000.

5. The sealant composition according to claim 1, wherein (B) comprises a polyaspartic ester of the formula: 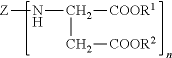
wherein: n is an integer of 2 to 6; Z represents an aliphatic residue; and R¹ and R² represent the same or different organic groups and are inert to isocyanate groups under reaction conditions.

6. The sealant composition according to claim 1, wherein (B1) comprises a polyaspartic ester selected from the group consisting of formulae (III), (IV) and (V):

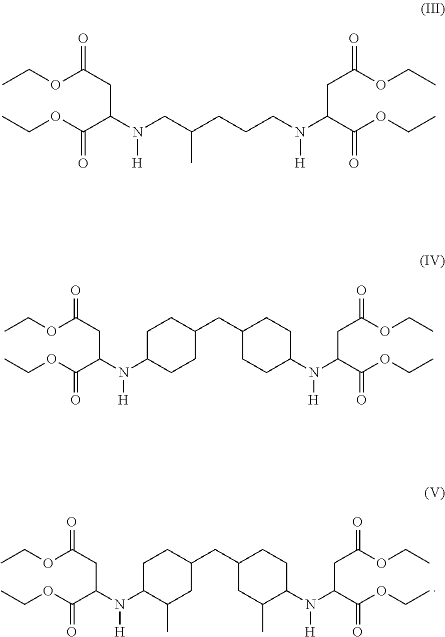

7. The sealant composition according to claim 6, wherein (B) further comprises a polyether diol.

8. The sealant composition according to claim 7, wherein a relative weight ratio of the polyether diol to the polyaspartic ester in the mixture is 1:1: to 1:2.

9. The sealant composition according to claim 6, wherein the polyaspartic ester is present in component (B) in an amount 30 to 50 percent by weight, based on the total weight of reactants in component (B).

10. The sealant composition according to claim 1, wherein a ratio of isocyanate groups of component (A) to isocyanate-reactive groups of component (B) is 1:1 to 1.5:1.
